(19) United States
(12) Patent Application Publication
(10) Pub. No.: US 2021/0238459 A1
(43) Pub. Date: Aug. 5, 2021

(54) REWORKABLE ADHESIVE COMPOSITION

(71) Applicants: HENKEL AG & CO, KGAA., Duesseldorf (DE); HENKEL IP & HOLDING GMBH, Duesseldorf (DE)

(72) Inventors: Zhuming SHI, Shanghai (CN); Cheng LU, Shanghai (CN); Yuheng YANG, Shanghai (CN); Nigel SWEENEY, Dublin (IE); Brendan KNEAFSEY, Dublin (IE)

(21) Appl. No.: 17/239,453

(22) Filed: Apr. 23, 2021

Related U.S. Application Data
(63) Continuation of application No. PCT/CN2018/112007, filed on Oct. 26, 2018.

(51) Int. Cl. C09J 151/00

(52) U.S. Cl. CPC C09J 151/003

(57) ABSTRACT

This invention relates to a reworkable adhesive composition for assembling optical electronic devices. In particular, the present invention relates to a reworkable adhesive composition offering, when cured, a good bonding strength at room temperature and an excellent reworkability at elevated temperature.

### TECHNICAL FIELD

This invention relates to a reworkable adhesive composition for assembling electronic devices. In particular, the present invention relates to a reworkable adhesive composition offering, when cured, a good bonding strength at room temperature and an excellent reworkability at elevated temperature.

### BACKGROUND OF THE INVENTION

Typical (meth)acrylic based structural adhesives show strong adhesive performance on most common substrates. Such adhesives have been found a growing use in the automotive industry and electronic products where the adhesive bonding is replacing welding and mechanical fastening techniques. However, these applications give rise to unique requirements not easily met by previously available adhesives. These requirements include high bond strength and improved adhesion failure mode when the joint parts are used in daily life. Yet nowadays, the reworkable requirement is proposed when the parts are assembled to avoid the misattachments especially for the laptop frame bonding and mobile phone back cover bonding. The new requirements require the (meth)acrylic based structural adhesives to have not only good bonding performance but also an excellent reworkablility. Also, the (meth)acrylate adhesives are required to have flexible and good aging performance.

Therefore, there is still a need to develop a reworkable adhesive composition which when cured, has a good adhesion strength at room temperature and an excellent reworkability at elevated temperature.

### SUMMARY OF THE INVENTION

The present invention provides reworkable adhesive compositions which overcome the abovementioned disadvantage of present (meth)acrylic based structural adhesives. The reworkable adhesive compositions in this invention achieve good bonding strength at room temperature when cured. The reworkable adhesive compositions in this invention exhibit good bonding strength after aging when cured. The reworkable adhesive compositions in this invention also have excellent reworkability at elevated temperature. Besides, the application of the reworkable adhesive composition is simple and suitable for industrial production.

The present invention, in general, provides a reworkable adhesive composition, comprising,
(1) a first (meth)acrylic monomer, having a glass transition temperature higher than 130° C.,
(2) a second (meth)acrylic monomer, having a glass transition temperature from 80° C. to 130° C.,
(3) a third (meth)acrylic monomer, having a glass transition temperature greater than or equal to 0° C. and less than 80° C.,
(4) a polymeric elastomer, and
(5) an initiator.

The present invention also provides an article comprising a first substrate, a second substrate, and an adhesive bonding the first substrate and the second substrate and formed by the curing of a reworkable adhesive composition according to the present invention.

The present invention also provides a process of bonding a first substrate to a second substrate, comprising applying a reworkable adhesive composition according to the present invention to the first substrate, placing a second substrate into contact with reworkable adhesive composition, and allowing sufficient time for the reworkable adhesive composition to cure to bond the first substrate to the second substrate.

The present invention also provides a kit for providing a two-part reactive adhesive formulation, said kit comprising a Part A chamber and a Part B chamber, said Part A chamber containing a Part A composition, said Part B chamber containing a Part B composition which is reactable with said Part A composition, said Part A composition and said Part B composition being combinable in a preselected weight ratio to yield the adhesive composition according to the present invention.

### BRIEF DESCRIPTION OF THE DRAWINGS

FIG. 1 is a schematic representation of a two-chamber applicator adapted to dispense a two-part reactive adhesive according to the present invention.

FIG. 2 and FIG. 3. are the top views for steps of preparing test samples using the two-part reactive adhesive according to the present invention to bond a PC-ABS alloy substrate and an ink coated glass substrate.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

According to the present invention, the reworkable adhesive composition comprises a first (meth)acrylic monomer, having a glass transition temperature (Tg) higher than 130° C., preferably from 160° C. to 250° C., and more preferably from 160° C. to 230° C.

As used herein, “a monomer having a glass transition temperature or Tg” refers to a monomer that, when in homopolymer form, displays a glass transition temperature as specified. Glass transition temperature may be measured, for example, by differential scanning calorimetry (DSC).

As used herein, “(meth)acrylic” should be understood as methacrylic and acrylic both.

As used herein, “(meth)acrylic monomer” includes but not limited to monofunctional or difuntional (meth)acrylic acid, (meth)acrylate, and (meth)acrylamide.

Examples of the first (meth)acrylic monomer include but not limited to methacrylic acid (Tg 228° C.), glacial methylic acid (Tg 185° C.), isobornyl methacrylate (Tg 180° C.), dicyclopentadieyl methacrylate (Tg 175° C.), acrylamide (Tg 165° C.), methacryamide (Tg 250° C.). Two or more of the first (meth)acrylic monomer may be used in combination. Preferably, the first (meth)acrylic monomer is selected from isobornyl methacrylate, methacrylic acid, and combination thereof.

In the present invention, the first (meth)acrylic monomer is present in an amount of 20% to 50%, preferably 30% to 40% by weight based on the total weight of the reworkable adhesive composition.

The second (meth)acrylic monomer contained in the reworkable adhesive composition has a glass transition temperature from 80° C. to 130° C., preferably from 90° C. to 120° C., and more preferably from 100° C. to 120° C.

Examples of the second (meth)acrylic monomer include but not limited to 2,2,2-trifluoroethyl methacrylate (Tg 81° C.), cyclohexyl methacrylate (Tg 83° C.), isobornyl acrylate (Tg 95° C.), tert-butyl methacrylate (Tg 107° C.), methyl methacrylate (Tg 105° C.), dihydrocyclopertadienyl acylate (Tg 110° C.), dicyclopertadienyl acylate (Tg 120° C.), glacial acrylic acid (Tg 106° C.), acrylic acid (Tg 106° C.), N-tert-butylacrylamide (Tg 128° C.), N,N-dimethylacrylamide (Tg 89° C.). Two or more of the second (meth)acrylic monomer may be used in combination. Preferably, the second (meth)acrylic monomer is methyl methacrylate.

In the present invention, the second (meth)acrylic monomer is present in an amount of 5% to 50%, preferably 10% to 40% by weight based on the total weight of the reworkable adhesive composition.

The third (meth)acrylic monomer contained in the reworkable adhesive composition has a glass transition temperature greater than or equal to 0° C. and less than 80° C., preferably from 10° C. to 70° C., and more preferably from 20° C. to 60° C.

Examples of the third (meth)acrylic monomer include but not limited to methyl acrylate (Tg 10° C.), 2-phenoxyethyl acrylate (Tg 5° C.), 2-phenoxyethyl methacrylate (Tg 36° C.), n-butyl methylate (Tg 20° C.), 2-hydroxypropyl acrylate (Tg 24° C.), 2-hydroxypropyl methacrylate (Tg 26° C.), isobutyl methacrylate (Tg 48° C.), allyl methacrylate (Tg 52° C.), benzyl methacrylate (Tg 54° C.), tert-butyl acrylate (Tg 55° C.), 2-hydroxyethyl methacrylate (Tg 55° C.), tetrahydrofurfuryl methacrylate (Tg 60° C.), ethyl methacrylate (Tg 65° C.). Two or more of the third (meth)acrylic monomer may be used in combination. Preferably, the third (meth)acrylic monomer is tetrahydrofurfuryl methacrylate, 2-phenoxyethyl methacrylate, and combination thereof.

In the present invention, the third (meth)acrylic monomer is present in an amount of 1% to 40%, preferably 5% to 30% by weight based on the total weight of the reworkable adhesive composition.

According to the present invention, the reworkable adhesive composition can optionally comprise a fourth (meth)acrylic monomer, having a glass transition temperature below 0° C., and preferably from −5° C. to −100° C.

Examples of the fourth (meth)acrylic monomer include but not limited to 2-ethylhexyl methacrylate (Tg −10° C.), ethyl acrylate (Tg −24° C.), n-butyl acrylate (Tg −54° C.), n-dodecyl acrylate (Tg −3° C.), 2,2,2-trifluoroethyl acrylate (Tg −10° C.), n-hexyl methacrylate (Tg −5° C.), n-octyl methacrylate (Tg −20° C.), n-dodecyl methacrylate (Tg −65° C.), n-octadecyl methacrylate (Tg −100° C.), and 4-hydroxy-n-butyl acrylate (Tg −40° C.). Two or more of the third (meth)acrylic monomer may be used in combination. Preferably, the fourth (meth)acrylic monomer is 2-ethylhexyl methacrylate.

In the present invention, the fourth (meth)acrylic monomer may be present in an amount of 1% to 20%, preferably 5% to 10% by weight based on the total weight of the reworkable adhesive composition.

The polymeric elastomer suitable to be used in the present invention is preferably chlorosulfonated polyethylene or chlorinated polyethylene, more preferably nitrile rubber particles or powder, all-acrylic copolymer resins or all-acrylic rubber particles, more preferably polymeric elastomers which are soluble in methacrylate/acrylate monomers, more preferably core shell polymers or block copolymer rubber, and most preferably polychloroprene, or mixtures of the foregoing.

The polychloroprene rubber is preferably neoprene, such as Neoprene AD-5, AD-10 or WRT, available from DuPont Dow Elastomers. The block copolymer rubber is preferably block copolymers of either butadiene or isoprene with styrene (for example, SBS, SIS, SEBS and SB) and are available from Shell Chemical Co. as Kraton D-1116 and other Kraton D-grade elastomers or Vector 2411IP from Dexco. Other elastomers with Tg below about 25 (degree) C., which are soluble in methacrylate/acrylate monomers, can be used in place of the polychloroprene and/or the block copolymer rubbers. Examples of such are homopolymer of epichlorohydrin and its copolymers with ethylene oxide, available from Zeon Chemicals as Hydrin, acrylate rubber pellets, available from Zeon as HyTemp, polyisoprene rubber, polybutadiene rubber, nitrile rubber, and SBR rubber (random copolymer of butadiene and styrene).

The core shell polymer is preferably a graft copolymer of the “core-shell” type. Preferred core shell polymers are acrylonitrile-butadiene-styrene (ABS), methacrylate-butadiene-styrene (MBS), and methacrylate-acrylonitrile-butadiene-styrene (MABS). Blendex 338 is an ABS powder from GE Plastics. Less preferred alternatives to the core shell polymer are all-acrylic copolymer resins such as Product Nos. KM330 and KM323B from Rohm and Haas. The preferred nitrile rubber powder is available from Goodyear as Chemigum P-83. Optionally, all-acrylic rubber particles, such as Sunigum, from Goodyear, can be used. Other resin fillers known in the art, which swell but do not dissolve in the monomer solution, can be used in place of nitrile rubber powder to provide paste-type consistency and further toughen the cured adhesive.

In one embodiment, the polymeric elastomer is selected from styrene-butadiene-styrene, styrene-ethylene-butadiene-styrene, acrylonitrile-butadiene-styrene, and combination thereof. As in known, the reworkable adhesive composition can be used as a two-part adhesive composition comprising Part A and Part B components. One or more polymeric elastomers can be contained in any one component or both components.

In the present invention, the polymeric elastomer is present in an amount of 5% to 60%, preferably 10% to 50% by weight based on the total weight of the reworkable adhesive composition.

The initiator used in the present invention is a free-radical initiator and is preferably a perester or peracid, most preferably an organic peroxide or organic hydroperoxide. Preferred initiators in the present invention are benzoyl peroxide (BPO), tert-butylperoxybenzoate (TBPB), cumene hydroperoxide (CHP), tertiary butyl hydroperoxide, dicumyl peroxide, and tertiary butyl peroxide acetate. A preferred initiator is Benox-50 (B-50) (from The Norac Company, Inc., Azusa, Calif.), a peroxide paste believed to contain 50% benzoyl peroxide, about 18% water and about 30% non-phthalate benzoate ester. More preferably, the initiator is Varox ASNS from R.T. Vanderbilt, Norwalk, Conn., a peroxide paste which is believed to contain 55% BPO, about 12% water and about 30% butyl phthalate plasticizer. Five grams of Benox-50 provides 2.5 g initiator based on 100% peroxide. Preferably, the initiator is provided in a paste (such as Benox-50 or Varox ANS), which contains at least 5, 10, 20, 30 or 40 weight percent BPO or other organic peroxide and preferably less than 18, 17, 16 or 14 weight percent water.

In the present invention, the initiator is present in an amount of 5% to 60%, preferably 10% to 50% by weight based on the total weight of the reworkable adhesive composition.

In accordance with some embodiments of the present invention, the reworkable adhesive compositions described herein may further comprise one or more vinyl-terminated liquid rubber, adhesion promoters, activator, catalyst, wax, plasticizer, and inhibitor and the like, as well as mixtures of any two or more thereof, as long as the advantages achieved by the adhesive composition are not negatively influenced.

The vinyl-terminated liquid rubber which may be optionally comprised in the adhesive composition is preferably vinyl-terminated liquid rubbers known in the art (such as liquid polybutadienes and/or liquid polyisoprenes and copolymers thereof), more preferably polyether or polyester polyol and other oligomeric material with vinyl functional terminal groups that have a glass transition temperature below 0° C., more preferably methacrylate-terminated or acrylate-terminated polybutadiene-acrylonitrile copolymers such as Hycar VTBN, and most preferably methacrylate-terminated or acrylate-terminated polybutadiene such as Hycar VTB from BF Goodrich.

In the present invention, the vinyl-terminated liquid rubber is present in an amount of 0.1% to 10%, preferably 1% to 5%, by weight of the total weight of the adhesive composition.

The composition may, optionally, also include a catalyst for promoting reaction of the ethylenically unsaturated monomer and the initiator. Traditionally, such compositions incorporate catalysts such as tertiary amines, substituted phosphines, salts of quaternary organophosphonium compounds, guanidines, imidazoles, and the like. Representatives of tertiary amines include N,N-diisopropanol-p-chloroaniline, N,N-diisopropanol-p-bromoaniline, N,N-diisopropanol-p-bromo-m-methylaniline, N,N-dimethyl-p-chloroaniline, N,N-dimethyl-p-bromoaniline, N,N-diethyl-p-chloroaniline, N,N-diethyl-p-bromoaniline, N,N-dimethyl-p-aniline, N,N-dimethyl-p-toluidine (DMPT); N,N-diethyl-p-toluidine, N,N-diisopropanol-p-toluidine, dihydroxyethyl-p-toluidine (DHEPT), bis(hydroxyethyl)-p-toluidine. Examples of guanidines include dicyandiamide, methylguanidine, ethylguanidine, propylguanidine, butylguanidine, dimethylguanidine, trimethylguanidine, phenylguanidine, diphenylguanidine, and toluylguanidine. Examples of substituted phosphines include tri(2,6-dimethoxyphenyl)phosphine, tri(para-tolyl)-phosphine, triphenylphosphine and triphenylphosphine. Examples of imidazoles include 2-methyl imidazole, 2-phenyl imidazole, 2-undecyl imidazole, 2-heptadecyl imidazole, and 2-ethyl-4-methyl imidazole. Salts of quaternary organophosphonium compounds which may be used include, but are not limited to, organophosphonium functional acetic acid ester compounds, such as ethyltriphenylphosphonium acid acetate complex commercially available from Rohm and Haas.

The adhesive composition may optionally contain an adhesion promoter to enhance the adhesion between the adhesive and metallic substrate. Adhesion promoters useful herein are the known phosphorus-containing compounds with mono-esters of phosphinic, mono- and diesters of phosphonic and phosphoric acids having one unit of vinyl or allylic unsaturation present. Vinylic unsaturation is preferred. Representative of the phosphorus-containing adhesion promoters are, without limitation, phosphoric acid; 2-methacryloyloxyethyl phosphate; bis-(2-methacryloxyloxyethyl)phosphate; 2-acryloyloxyethyl phosphate; bis-(2-acryloyloxyethyl)phosphate; methyl-(2-methacryloyloxyethyl)phosphate; ethyl methacryloyloxyethyl phosphate; methyl acryloyloxyethyl phosphate; ethyl acryloyloxyethyl phosphate; propyl acryloyloxyethyl phosphate, isobutyl acryloyloxyethyl phosphate, ethylhexyl acryloyloxyethyl phosphate, halopropyl acryloyloxyethyl phosphate, haloisobutyl acryloyloxyethyl phosphate or haloethylhexyl acryloyloxyethyl phosphate; vinyl phosphonic acid; cyclohexene-3-phosphonic acid; (α-hydroxybutene-2 phosphonic acid; 1-hydroxy-1-phenylmethane-1,1-diphosphonic acid; 1-hydroxy-1-methyl-1-disphosphonic acid; 1-amino-1-phenyl-1,1-diphosphonic acid; 3-amino-3-hydroxypropane-1,1-disphosphonic acid; amino-tris(methylenephosphonic acid); γ-amino-propylphosphonic acid; γ-glycidoxypropylphosphonic acid; phosphoric acid-mono-2-aminoethyl ester; allyl phosphonic acid; allyl phosphinic acid; 8-methacryloyloxyethyl phosphinic acid; diallylphosphinic acid; β-methacryloyloxyethyl)phosphinic acid and allyl methacryloyloxyethyl phosphinic acid. Examples are those sold under the trade name Sipomer PAM-100 and PAM 200 by Rhodia, Light Ester PM-1 and PM-2 by Kyoeisha Chemicals Company, and Sartomer CD 9052 or CD9053 by Sartomer. A preferred adhesion promoter is methacryloyloxyethyl phosphate.

Further adhesion promoters useful herein are the known alkenyl functional silanes, having an unsaturated organic moiety bonded to the silicone atom, for example an unsaturated acrylic, vinyl, allyl, methallyl, propenyl, hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl or styryl groups. Other alkenyl functional organometallics include titanates, such as vinylalkyl titanates, zirconates, zinc diacrylate, and zinc dimethacrylates.

Waxes may be used in the adhesive composition to increases open time and is preferably honey bee wax or chlorinated wax or other waxes, more preferably Wax 58 from IG International. A polymeric resin which acts as a thixotropic agent and/or toughener, such as polyamide powder such as Disparlon 6200 from King Industries may be added. Antioxidants such as BHT may also be used. Other optional ingredients include scavengers or chelators, such as EDTA, pigments, dyes, reinforcing fibers, etc.

A suitable plasticizer also optionally added in the adhesive composition can be a high-boiling temperature solvent or a softening agent. An example of a suitable plasticizer is an ester made from an anhydride or acid and a suitable alcohol having from about 6 carbon atoms to about 13 carbon atoms. Other suitable plasticizers include adipate, phosphate, benzoate or phthalate esters, polyalkylene oxides, sulfonamides, and the like. The plasticizers include dioctyl adipate plasticizer (DOA), triethylene glycol di-2-ethyl hexanoate plasticizer (TEG-EH), trioctyl trimellitate plasticizer (TOTM), glyceryl triacetate (triacetin plasticizer), 2,2,4-trimethyl-1,3-pentanediol diisobutyrate plasticizer (TXIB), diethyl phthalate plasticizer (DEP), dioctyl terephthalate plasticizer (DOTP), dimethyl phthalate plasticizer (DMP), dioctyl phthalate plasticizer (DOP), dibutyl phthalate plasticizer (DBP), ethylene oxide, toluene sulfonamide, and dipropylene glycol benzoate. Other commercially available plasticizers may also be useful.

The phosphate ester is preferably functional phosphate esters, such as are described in U.S. Pat. Nos. 4,223,115 and 4,769,419, more preferably methacrylate phosphate esters, such as the phosphate ester of 2-hydroxyethyl methacrylate (preferably not more than 80% esterified), an example of which is commercially available as P-2M from Polymer Systems, Japan, or T-Mulz 1228 from Hacros Chemicals, Pennsylvania. The addition of phosphate ester improves primerless metal bonding by acting as an adhesion promoter.

The inhibitor is a free-radical polymerization inhibitor, which increases shelf life and prevents or inhibits premature polymerization and is preferably BHT or other known free-radical polymerization inhibitors, more preferably hydroquinone (HQ) or methylhydroquinone (MEHQ).

The scavenger (of metal ions) is preferably EDTA salt and other known scavengers or chelators.

As is known in the art, the adhesive compositions according to the present invention are two-part, reactive adhesives which are prepared in a Part A and a Part B, and are maintained separated in a Part A chamber and a Part B chamber. The chambers can be, for example, compartments or separate containers or barrels or pails. Parts A and B are combined at the time of use, when they react and form the final adhesive. As is known in the art, there is wide latitude in which ingredients are put in the Part A and which ingredients are put in the Part B. An important requirement is that the ingredients which will initiate the reaction be kept separate or apart from the materials they will react with. This can be seen in the Examples which follow. The typical division into Parts A and B is known in the art and as shown in the Examples herein. Typically 50 parts by weight of Part A are combined with 50 part by weight of Part B. Alternatively the ratio of A:B can be about 10:1, 5:1, 3:1, 2:1, 1:1, 1:2, 1:3, 1:5 or 1:10 or other ratios.

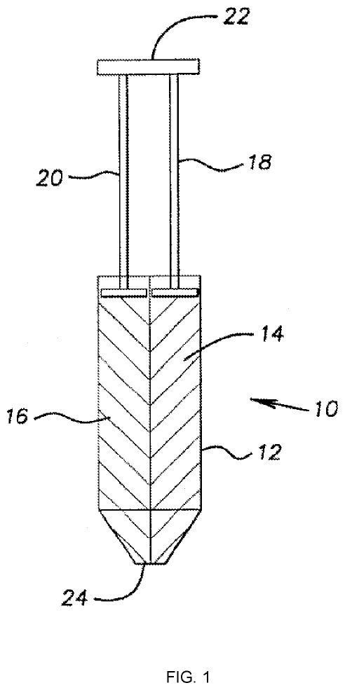

With reference to FIG. 1, there is shown an applicator or kit 10 having a barrel 12 which has a nozzle 24. The barrel 12 includes two separate chambers or compartments, a first chamber 14 containing Part A of an adhesive composition according to the present invention and a second chamber 16 containing a corresponding Part B of an adhesive composition according to the present invention. The applicator 10 also has a pair of plungers 18 and 20 joined by a dual plunger handle 22. When the handle 22 is pushed down, Part A and Part B are expelled from their respective chambers and join and mix together as they come out of the nozzle 24. They are then preferably further mixed together so they can fully react to form the final adhesive. Alternatively a kit can be provided comprising a 55 gallon drum or barrel or chamber of Part A and a 55 gallon pail or chamber of Part B, to be mixed in an A:B ratio of 1:1.

The present invention also provides a kit for providing a two-part reactive adhesive formulation, said kit comprising a Part A chamber and a Part B chamber, said Part A chamber containing a Part A composition, said Part B chamber containing a Part B composition which is reactable with said Part A composition, said Part A composition and said Part B composition being combinable in a preselected weight ratio to yield an adhesive composition comprising a first (meth)acrylic monomer, having a glass transition temperature higher than 130° C., a second (meth)acrylic monomer, having a glass transition temperature from 80° C. to 130° C., a third (meth)acrylic monomer, having a glass transition temperature from greater than or equal to 0° C. and less than 80° C., a polymeric elastomer, and an initiator.

The reworkable adhesive composition according to the present invention can be prepared by mixing all components together to gain homogenous mixture. The mixing can be done at room temperature. The mixing device can be for example orbital-motion (planetary) mixer, or compulsory mixer.

The reworkable adhesive composition of the present invention is in the form of liquid, and the Brookfield viscosity of the composition is preferably about 50 cPs to about 200,000 cPs at 25° C. The liquid adhesive composition in such range of viscosity has a good flowing property which makes it easy to be applied or injected onto a substrate.

Upon cure of an adhesive composition, an adhesive is produced with tensile strength above 5 Mpa for the bonding of PC-ABS alloy (polycarbonate/poly(acrylonitrile-co-butadiene-co-styrene)) and ink coated glass. Another key aspect is bond consistency and durability to humid environments up to 65° C. The resulting adhesive is able to bond to a variety of substrates, such as magnesium-aluminum alloys, a polyamide-6,6, a polyamide alloy, a polyamide-4,10 alloy, aluminum, polycarbonate (PC), Acrylonitrile-Butadiene-Styrene (ABS), PC-ABS alloys, PC-styrene-acrylonitrile alloys, ink coated glass, and polyethylene terephthalate, polybutylene terephthalate laminated or coated ink-glass. Preferably, the adhesive produced is resistant to aging at elevated temperature and humidity. Reworkability of the adhesive composition is based on highly clean removal of the cured adhesive system from adherent substrates above 60° C. and typically from 70° C. to 100° C.

A process of bonding a first substrate to a second substrate is also provided that includes the application of the above adhesive composition to first substrate as a bead or line. A second substrate is placed in contact with the bead or line and the composition is allowed to cure. By heating the cured adhesive to 60° C. and above, the adhesive is amenable to being removed, repaired, or reworked.

The following examples are intended to assist one skilled in the art to better understand and practice the present invention. The scope of the invention is not limited by the examples but is defined in the appended claims. All parts and percentages are based on weight unless otherwise stated.

### EXAMPLES

The following materials were used in the examples. MMA is methyl methacrylate from Evonik. MAA is methacrylic acid from Sinopharm. THFMA is Tetrahydrofurfuryl methacrylate, from TCI. IBOMA is Isobornyl methacrylate from TCI. EHMA is ethylhexyl methacrylate from Evonik. Blend338 is polyoacrynitrile-b-butendiene from GE. Core-shell-2670 is Poly(methacrylate-butadiene-styrene) from DOW. 1116K is Poly(styrene-butadiene-styrene) from Kraton. TMPTMA is Trimethylolpropane trimethacrylate from TCI. VTB is a vinyl-terminated liquid rubber from CRAY VALLEY. P1-M is an adhesive promoter from Kyeisha. DMPT is N,N-dimethyl-p-toluidine from Sinopharm. Wax 58 is a wax from Sinopharm. HEPT is dihydroxyethyl-p-toluidine from Sinopharm. N-tert-Butyl acrylamide is from Sinopharm. BHT is 2,6-di-tert-butyl-p-cresol from Sinopharm. 2021 is poly(methyl methacrylate) from Lucite International. PhEMA is phenoxyethylmethacrylate from TCI. BPO is benzoyl peroxide from Sinopharm. EPON 828 is diglycidylether of bisphenol A from Hexion Specialty Chemicals GmbH. Kraton G 1652 is SEBS copolymer from Kraton. DOTP is dioctyl tetrahydrophthalate from Sinopharm. Ultramarine blue colorant is available from Tianlan.

Two-part adhesive compositions were prepared as Examples (Ex.) and Comparative Examples (CEx.). Part A of the compositions were formulated according to the components and amounts in Table 1 by mixing well all components with a Speed mixer DAC400 (from FlackTek Inc.) until the mixture was dissolved completely to obtain Part A. All components of Part B were mixed well by using a three-roll mill to obtain a homogenous Part B according to the components and amounts in Table 2. Part A and Part B were mixed together at a weight ratio of 10:1 when being applied on substrate.

TABLE 1
Formulations of Part A of the adhesive compositions (in gram)

| | Ex. 1 | CEx. 1 | Ex. 2 | CEx. 2 | Ex. 3 | Ex. 4 |
|---|---|---|---|---|---|---|
| MMA | 10 | 9 | 9 | 9 | 9 | 9 |
| THFMA | 3 | 9 | 9 | 9 | 9 | 9 |
| IBOMA | | | 2 | | 2 | 2 |
| EHMA | 3 | | | 2 | 2 | |
| MAA | 1 | | | | | |
| Blend338 | | 2 | 0.4 | 2 | 0.4 | 0.4 |
| Core-shell-2670 | 2 | | 1.6 | | 1.6 | 1.6 |
| 1116K | 10 | 9 | 8 | 9 | 8 | 8 |
| TMPTMA | 1 | 1 | 1 | 1 | 1 | 1 |
| P1-M | 0.25 | 0.1 | 0.1 | 0.1 | 0.1 | 0.1 |
| VTB | 2.5 | 2.5 | 1.5 | 2.5 | 1.5 | 1.5 |
| Wax-58 | 0.2 | 0.2 | 0.2 | 0.2 | 0.2 | 0.2 |
| DMPT | 0.35 | 0.6 | 0.6 | 0.6 | 0.6 | 0.6 |
| HEPT | 0.25 | 0.25 | 0.25 | 0.25 | 0.25 | 0.25 |
| N-tert-Butyl | 0.25 | 0.25 | 0.25 | 0.25 | 0.25 | 0.25 |
| acrylamide | | | | | | |
| BHT | | 0.02 | 0.02 | 0.02 | 0.02 | 0.02 |
| 2021 | | | | 1.4 | 1.4 | |
| PhEMA | | | | 1.4 | 1.4 | |

TABLE 2
Formulations of Part B of the adhesive compositions (in gram)

| | Ex. 1 | CEx. 1 | Ex. 2 | CEx. 2 | Ex. 3 | Ex. 4 |
|---|---|---|---|---|---|---|
| SEBS | 13.2 | 10.9 | 10.9 | 10.9 | 10.9 | |
| DOTP | 24.2 | 20.0 | 20.0 | 20.0 | 20.0 | 34.2 |
| EPON 828 | 23 | 19.0 | 19.0 | 19.0 | 19.0 | 1 |
| BPO | 39.5 | 50.0 | 50.0 | 50.0 | 50.0 | 39.5 |
| Ultramarine blue | 0.07 | 0.07 | 0.07 | 0.07 | 0.07 | 0.07 |
| Core-shell-2670 | | | | | | 13.2 |

Performance Evaluation

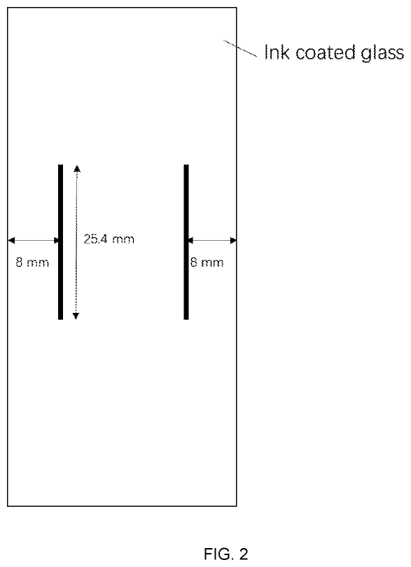

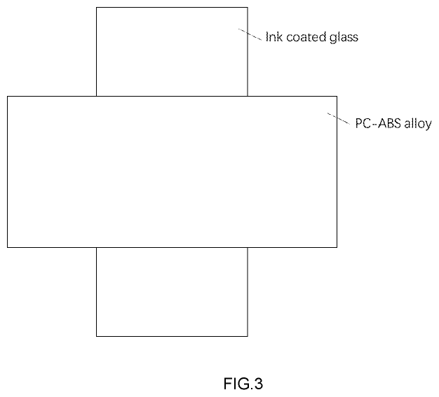

Test sample was formed by bonding the substrates of PC-ABS alloy (available from Dongguan Baiside Plastic Co., Ltd.) and ink coated glass (available from Dongguan Baiside Plastic Co., Ltd.) with the two-part adhesive composition by the following procedure:
a) a PC-ABS alloy substrate with the size of 101.6 mm×25.4 mm, and an ink coated glass substrate with the size of 101.6 mm×25.4 mm were prepared;
b) two spacers with a height of 127 μm were placed on the surface of the ink coated glass substrate;
c) two parallel lines (25.4 mm length) of the two-part adhesive composition were applied to the center of the ink coated glass substrate by adhesive dispenser (400D available from Henkel), and the two parallel lines were also parallel to the long edge of the ink coated glass substrate as shown in FIG. 2. Each line of the two-part adhesive composition was 8 mm from the long edge of the ink coated glass substrate;
d) the PC-ABS alloy substrate was vertically placed over the ink coated glass substrate so that the two parallel lines of the two-part adhesive composition were at the center of the PC-ABS alloy substrate, and were parallel to the short edge of the PC-ABS alloy substrate as shown in FIG. 3;
e) a weight block of 2 Kg was placed on top of the PC-ABS alloy substrate, and the two-part adhesive composition was cured at room temperature for 24 hours;
f) the spacers were removed;
g) the bonded area (A) was measured by microscope;
h) the PC-ABS alloy substrate and an ink coated glass substrate were reinforced with steels of the same length and width as backlinings (SS304 from Dongguan Baiside Plastic Co., Ltd.).

Bonding Strength at Room Temperature

The test sample was tested by Instron 5669 tester at a crosshead speed of 2 mm/min at room temperature, and the force load at failure (L) was recorded.

The bonding strength of two-part adhesive composition was calculated by: force load at failure (L)/bonded area (A).

Bonding Strength at Room Temperature after Aging

The test sample was firstly aged at 65° C. for 168 hours with the humility controlled at 95%. The bonding strength of two-part adhesive composition was obtained by the same method as described above.

Reworkability

The test sample was firstly heated to 60° C. for 10 minutes. The bonding strength of two-part adhesive composition was obtained by the same method as described above. The failure mode of test sample also observed when the two substrates were de-bonded. “Ink-f” means the two substrates were de-bonded, and the cured product of the two-part adhesive composition was not on the ink coated glass substrate; “MF” means that the two substrates were de-bonded for various reasons. For example, the two substrates were de-bonded, but the cured product of the two-part adhesive composition was still attached to the ink coated glass substrate; and the two substrates were de-bonded, but the cured product of the two-part adhesive composition were still attached to both of the ink coated glass substrate and the PC-ABS alloy substrate.

The test results were shown in Table 3. It is evident that all inventive examples exhibited good bonding strength even after aging and excellent reworkability with desired failure mode. However, the comparative examples show poorer bonding strength after aging and unsatisfied reworkability.

TABLE 3
Test results of bonding strength (in MPa)

| | Ex. 1 | CEx. 1 | Ex. 2 | CEx. 2 | Ex. 3 | Ex. 4 |
|---|---|---|---|---|---|---|
| Bonding | 7.5 | 4.5 | 7 | 7.5 | 8.7 | 7.9 |
| strength at room | | | | | | |
| temperature | | | | | | |
| Bonding | 6.0 | 2.5 | 3.5 | 5.8 | 8.3 | 6.8 |
| strength at | | | | | | |
| room temperature | | | | | | |
| after aging | | | | | | |
| Bonding | 1.4 | 2.4 | 1.6 | 2.2 | 2.1 | 1.5 |
| strength at 60° C. | | | | | | |
| Failure mode | Ink-f | MF | ink-f | MF | ink-f | ink-f |
| at 60° C. | | | | | | |

1. A reworkable adhesive composition, comprising,
(1) a first (meth)acrylic monomer, having a glass transition temperature higher than 130° C.,
(2) a second (meth)acrylic monomer, having a glass transition temperature from 80° C. to 130° C.,
(3) a third (meth)acrylic monomer, having a glass transition temperature greater than or equal to 0° C. and less than 80° C.,
(4) a polymeric elastomer, and
(5) an initiator.

2. The reworkable adhesive composition according to claim 1, wherein the first (meth)acrylic monomer has a glass transition temperature from 160° C. to 250° C.

3. The reworkable adhesive composition according to claim 1, wherein the first (meth)acrylic monomer is selected from methacrylic acid, glacial methylic acid, isobornyl methacrylate, dicyclopentadieyl methacrylate, acrylamide, methacryamide, and combination thereof.

4. The reworkable adhesive composition according to claim 1, wherein the second (meth)acrylic monomer has a glass transition temperature from 90° C. to 120° C.

5. The reworkable adhesive composition according to claim 1, wherein the second (meth)acrylic monomer is selected from methyl methacrylate, 2,2,2-trifluoroethyl methacrylate, cyclohexyl methacrylate, isobornyl acrylate, tert-butyl methacrylate, dihydrocyclopentadienyl acrylate, dicyclopentadienyl acrylate, glacial acrylic acid, acrylic acid, N-tert-butylacryamide, N,N-dimethylacryamide, and combination thereof.

6. The reworkable adhesive composition according to claim 1, wherein the third (meth)acrylic monomer has a glass transition temperature from 10° C. to 70° C.

7. The reworkable adhesive composition according to claim 1, wherein the third (meth)acrylic monomer is selected from methyl acrylate, 2-phenoxyethyl acrylate, 2-phenoxyethyl methacrylate, n-butyl methylate, 2-hydroxypropyl acrylate, 2-hydroxypropyl methacrylate, isobutyl methacrylate, allyl methacrylate, benzyl methacrylate, tert-butyl acrylate, 2-hydroxyethyl methacrylate, tetrahydrofurfuryl methacrylate, ethyl methacrylate, and combination thereof.

8. The reworkable adhesive composition according to claim 1, wherein the polymeric elastomer is selected from core shell polymers, block copolymer rubbers and mixtures thereof.

9. The reworkable adhesive composition according to claim 1, wherein the initiator is selected from benzoyl peroxide, tert-butylperoxybenzoate, cumene hydroperoxide, tertiary butyl hydroperoxide, dicumyl peroxide, tertiary butyl peroxide acetate, and combination thereof.

10. The reworkable adhesive composition according to claim 1, which further comprises a fourth (meth)acrylic monomer, having a glass transition temperature below 0° C.

11. An article, comprising a first substrate, a second substrate, and an adhesive bonding the first substrate and the second substrate and formed by the curing of a reworkable adhesive composition according to claim 1.

12. A process of bonding a first substrate to a second substrate, comprising applying a reworkable adhesive composition according to claim 1 to the first substrate, placing a second substrate into contact with reworkable adhesive composition, and allowing sufficient time for the reworkable adhesive composition to cure to bond the first substrate to the second substrate.

13. (canceled)

14. A kit for providing a two-component reactive adhesive formulation, said kit comprising a Part A chamber and a Part B chamber, said Part A chamber containing a Part A composition, said Part B chamber containing a Part B composition which is reactable with said Part A composition, said Part A composition and said Part B composition being combinable in a preselected weight ratio to yield an adhesive composition comprising a first (meth)acrylic monomer, having a glass transition temperature higher than 130° C., a second (meth)acrylic monomer, having a glass transition temperature from 80° C. to 130° C., a third (meth)acrylic monomer, having a glass transition temperature greater than or equal to 0° C. and less than 80° C., a polymeric elastomer, and an initiator.

15. A kit according to claim 14, wherein each of said Part A chamber and said Part B chamber is selected from the group consisting of drums, barrels and pails.
